(19) United States
(12) Patent Application Publication
(10) Pub. No.: US 2014/0090209 A1
(43) Pub. Date: Apr. 3, 2014

(54) SYSTEM, HOLDER, AND TERMINAL STRUCTURE FOR SUPPORTING A MOBILE DEVICE AND EXTERNAL ARTICLES

(71) Applicant: Mark Smith, Larkspur, CA (US)

(72) Inventor: Mark Smith, Larkspur, CA (US)

(21) Appl. No.: 14/043,394

(22) Filed: Oct. 1, 2013

Related U.S. Application Data
(60) Provisional application No. 61/708,357, filed on Oct. 1, 2012.

(51) Int. Cl. A45F 5/00; F16M 13/04

(52) U.S. Cl. CPC A45F 5/00; F16M 13/04
USPC 24/3.12; 248/314; 24/3.13

(57) ABSTRACT

In a holder system for supporting a mobile device therein, the system includes a base cavity adapted to hold the mobile device, which is removable therefrom, the base cavity having a plurality of slots adapted to receive terminals therein. The plurality of slots is further comprised of a first slot pattern of three slots at an upper end of the base cavity, and a second slot pattern of at least two slots below a midpoint of the base cavity's length. The system includes at least one external article adapted to be coupled to the base cavity via one of the terminals engaged in one of the slots.

### CROSS-REFERENCE TO RELATED APPLICATION

The present application claims the benefit under 35 U.S.C. §119(e) of U.S. Provisional Patent Application No. 61/708,357 to the inventor, filed Oct. 1, 2012, the entire contents of which is hereby incorporated by reference herein.

### BACKGROUND

1. Field

Example embodiments in general relate to a system, holder, and terminal structure for supporting a mobile device such as communication badges, cellular phones, pagers, PDAs, tools, equipment, etc., and external articles such as identification cards, additional tools and equipment, and the like.

2. Related Art

Article holder systems employing retraction exist for a wide variety of devices, users, and usages. Conventional holder systems have been developed for tools and other devices in shop environments mounted on stationary fixtures; for clippers or scissors on the vest of a person fly fishing; for badges on mobile people like IDs for workers or ski passes for skiers; for keys; for power cords on a mobile electrical vacuum cleaner; etc.

Hand-held mobile devices with speaker-phone or hands-free applications are well known. However, coupling a holder system with a mobile device with hands-free capability on the wearer in the vicinity of the chest or shoulder without using an ear bud or having to physically touch the device is desirable. Moreover, such a system could be advantageous to hold additional external items to the mobile device needed in a particular vocation, such as that of a health-care worker or construction worker being examples.

### SUMMARY

An example embodiment is directed to a holder system for supporting a mobile device therein. The system includes a base cavity adapted to hold the mobile device, which is removable therefrom, the base cavity having a plurality of slots adapted to receive terminals therein. The plurality of slots is further comprised of a first slot pattern of three slots at an upper end of the base cavity, and a second slot pattern of at least two slots below a midpoint of the base cavity's length. The system includes at least one external article adapted to be coupled to the base cavity via one of the terminals engaged in one of the slots.

Another example embodiment is directed to a holder for supporting a mobile device therein. The holder includes a base cavity adapted to hold the mobile device, the base cavity having a plurality of slots adapted to receive corresponding terminals therein, one or more of the terminals connected to external articles, a top end lip extending from the base cavity for bounding upper ends of the device, a bottom end lip extending from the base cavity for bounding lower ends of the device, and a plurality of side edge lips extending from the top and bottom end lips for partially bounding respective upper sides and lower sides of the device, the side edge lips configured to assist in holding and aligning the mobile device on the base cavity.

Another example embodiment is directed to a terminal structure usable with a holder for a mobile device, the holder having a plurality of slots for receiving the terminal structure. The terminal structure includes a base, a post attached to the base at one end of the base, a flange provided on the post, the flange adapted for engagement with a slot on the holder to secure the terminal structure to the holder, and a slot at the other end of the base for receiving an article external to the holder and mobile device.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a front view of a system for supporting a mobile device and external articles in accordance with an example embodiment, with the device being held by the wearer.

FIG. 2 is a perspective view of the system with the device in holder.

FIG. 3 is a perspective view of the system in an upper breast worn configuration.

FIG. 4 is a perspective view of the holder of the system in FIG. 1.

FIG. 5 is a top plan view of the holder.

FIG. 6 is a right-side elevational view of the holder.

FIG. 7 is a bottom plan view of the holder.

FIG. 8 is a front plan view of the holder.

FIG. 9 is a rear plan view of the holder.

FIG. 10 is a perspective view of the terminal of the system in FIG. 1.

FIG. 11 is a left-side elevational view of the terminal.

FIG. 12 is a front plan view of the terminal.

FIG. 13 is a top plan view of the terminal.

FIG. 14 is a perspective view of a terminal in accordance with another example embodiment.

FIG. 15 is a top plan view of the lanyard shown in the system of FIG. 1.

FIG. 16 is close-up enlarged top view showing the terminal to holder connections.

FIG. 17 is a perspective top view of the retractor mechanism shown in the system of FIG. 1 with terminal and ID holder connector attached thereto.

FIG. 18 is a perspective side view showing the underside of the retractor mechanism of FIG. 17 to illustrate selected components thereof.

FIG. 19 is a perspective top view of the clip shown in the system of FIG. 1 with terminal attached thereto.

FIG. 20 is a top plan view of the holder showing the terminal to holder connection for the upper breast worn configuration.

### DETAILED DESCRIPTION

As to be set forth more fully below, the example embodiments in general are directed to a system for holders which supports another electronic device such that the device is maintained in a stable orientation on the wearer while being accessed or engaged in use by one or more of the wearer's hands, ears, eyes, and spoken words.

As to be set forth more fully hereafter, various example embodiments are directed to a system, holder and terminal structure to support mobile electronic devices (“mobile devices”) such as a communication badges, cell phones, mp3 players, tools, equipment, identification badges, bar-code readers, and the like. In some examples the holder of the system is worn around a user's neck such that the device is suspended therein and at rest in front of the user's chest. In another embodiment the system may be worn close to the shoulder on the upper breast.

As to be shown by one or more of the figures, the example systems may employ a single spindle, multiple-spindle (2 or more) retraction system and/or retractor mechanism, which may hold the weight of a device or a device-holder base combination in a retracted position (e.g. upon the wearer's chest). Here, the wearer's device can be easily reached, seen, and/or otherwise used by the user or others. In this scenario, for example, the wearer could easily reach and pull the device-holder combination away from the retracted position to execute a task or inquiry or such. The multi-spindle configuration may be effected for example by use of a band or other known method of retraction of a cord around multiple spindles.

As used herein, the term “holder” will generally refer to an item configured to hold or support one or more of a mobile device and an external article such as a tool/non electronic device for use by a user. As used herein, the phrase “retractor mechanism” will generally refer to an item or apparatus that performs functions including: enabling a retractable line connected to a holder with device therein to be paid out under user action; locking of the line in a desired position, and retraction of the line upon release thereof by the user. The phrase as described is not meant to limit the component(s) in any way. Retraction and locking may be addressed by different components and/or different means; retraction and locking functions may be separated into different items. In some examples a locking means may be omitted (i.e., when the device and/or base are pulled out they may be always under tension). In some examples, the tension created by retraction may or may not support the weight of the device and/or base combination.

In some examples, the retraction force and/or torque may be applied through one or more combinations of lines, cords, fibers, ribbons, tubes, wires, chains, etc. In some examples the locking function may be accomplished with springs, counterweights, electromechanical and/or mechanical devices, a manual button, suction, inertia, gravity, magnetism, gears, pads, circuits, etc.

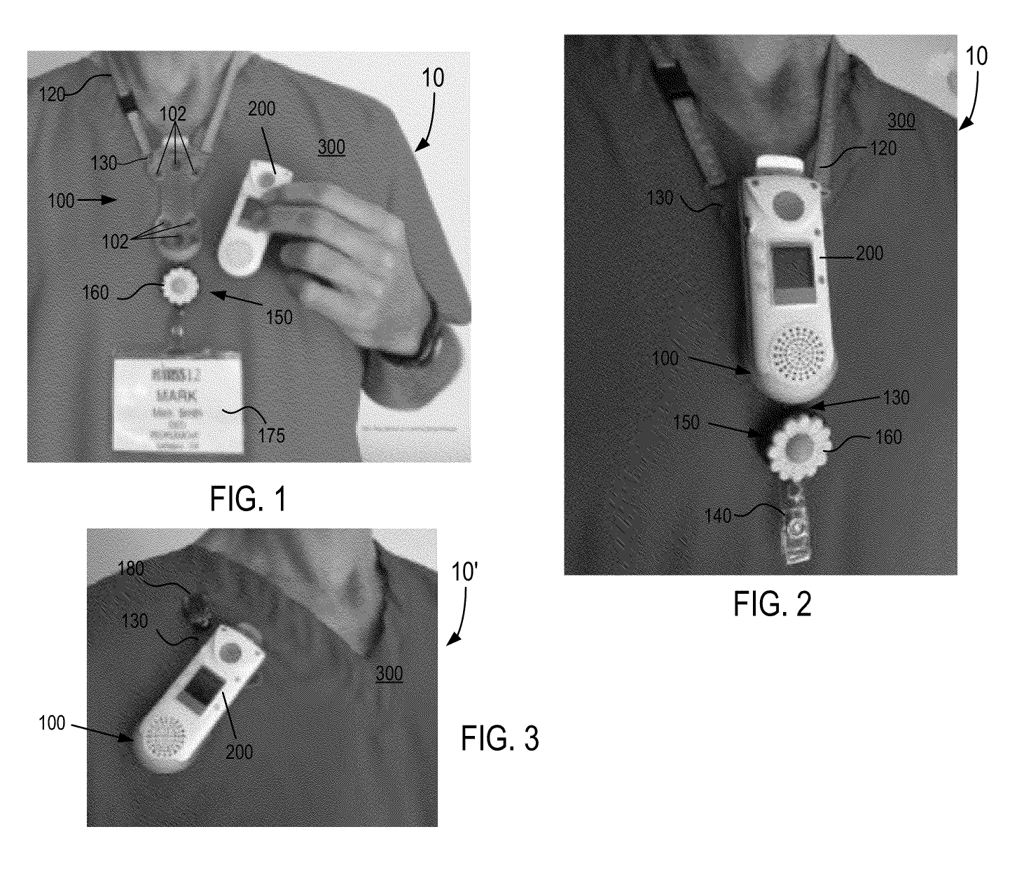

FIG. 1 is a front view of a system for supporting a mobile device and external articles in accordance with an example embodiment, with the device being held by the wearer; FIG. 2 is a perspective view of the system with the device in holder; and FIG. 3 is a perspective view of the system in an upper breast worn configuration.

Referring to FIGS. 1-3, system 10 includes a holder 100. Holder 100 is attached to a lanyard 120 worn around the neck of a wearer 300 by a pair of terminals 130. The system 10 herein is configured such that a mobile device 200 may be readily accessed by the wearer whether in a resting or static position or as it is raised or extended. In an example, the mobile device 200 is a Vocera® B3000 communications badge with hands-free voice-to-voice capabilities, such as is used by millions of health care workers in hospitals, clinics, and physicians' offices worldwide. This is merely one example. Device 200 may be an electronic device such as a cell phone, PDA, calculator, mp3 player, IPOD®, fluke, medical diagnostic device, or bar-code reader. Device 200 also could be a tool, notepad, binoculars, or other non-electronic article or object which is secured in the holder 100. In an alternative embodiment, the device 200 may be integrated and/or incorporate features of system 10, inclusive of retractor mechanisms 150, holder 100 with slots 102 and cooperating terminals 130. In other words, the device 200 can be designed at time of manufacture to include the mechanisms described as part of the example system 10 herein.

The holder 100 is configured so as to retain device 200 within the holder 100 so that the microphone or a microphone system may be oriented towards and closest to the mouth of the wearer 300. As to be described in detail hereafter, the device 200 clicks into the holder 100 so it is secured within a base cavity formed by edge lips and top and bottom lips with additional tabs for retaining the device 200 to the holder 100. The edge lips cooperate to align and retain the device 200 on the base cavity of holder 100. In alternative constructions the device 200 may be configured to slide into the base cavity, or one end of holder 100 may be formed as a movable end cap that may be temporarily moved allowing for insertion of the device 200 and then replaced to secure the device 200 therein. The device 200 may alternatively be secured to holder 100 via any of adhesion, straps, screws, buttons, snaps, etc. The holder 100 may also be height adjustable relative to the wearer's chest via lanyard 120.

The terminals 130 permit attachment of various external articles, one example being a retractor mechanism 150. The retractor mechanism 150 in turn is attached to a connector 140, which attaches an ID holder 175 to the retractor mechanism 150 and indirectly to the holder 100. Of course, the ID holder 175 or other external articles may be attached directly to the holder 100 via the terminals 130.

As best shown in FIG. 3, in a breast worn configuration shown as system 10′, a clip 180 (see also FIG. 19) may be attached to an upper outer slot 102 on holder 100 via a terminal 130. Here, the holder 100 and device 200 will naturally pivot and hang due to gravity such that the direction of the microphone system's optimal reception is in the direction of the mouth of the wearer 300, and does not require use of a lanyard 120. The clip 180 in turn is affixed to the clothing of the wearer 300. As in FIGS. 1 and 2, a retractor mechanism and/or ID badge holder could be attached via additional terminals 130. Optionally, decorative articles 160 such as gibbets may be attached directly to a terminal 130 or to external articles to personalize system 10. In a variant, the addition of a second clip 180 with terminal 130 to a lower outer slot in FIG. 1 can reduce swing of device 200 when attached to the wearer 300's garment.

Accordingly, the holder 100 permits device 200 to be easily, instantly, and reliably snapped in/out with one hand and without looking. Its extended width and flat back limit the tendency to rotate or “roll” so that the device 200 face, speaker, and microphones remain frontal. The lanyard 120 enables holder 100 to be worn in a lanyard mode. The length of the lanyard 120 ensures that the device 200 is a minimal distance from wearer 300's mouth and will have minimal swing. Additionally, the clip 180 enables holder 100 to be worn in various locations with partial and automatic or total control of yaw orientation, and/or with minimal and near-zero swing, depending on desired and chosen clip configuration(s). By adding a second clip to the configuration of FIG. 3 and described above, to a second slot along the top side as it hangs laterally, i.e. to a lower outer slot of the holder 100, and attaching it to the garment as desired, yaw can be adjusted and maintained such that the device 200's microphone is oriented towards the wearer 300's mouth through a wide range of locations on the wearer 300's body, and such that the device 200 is held more stably to the garment. In another example the terminal 130 for clip 180 could be affixed to holder 100 in the upper central slot 102 and thus provide for clipping holder 100 on a garment collar or other lanyard such that it hangs vertically and oriented towards the wearer 300's mouth. Clips 180 provided via terminals 130 in all four corner slots 102 would of course yield total control of yaw orientation and maximum stability with near-zero swing.

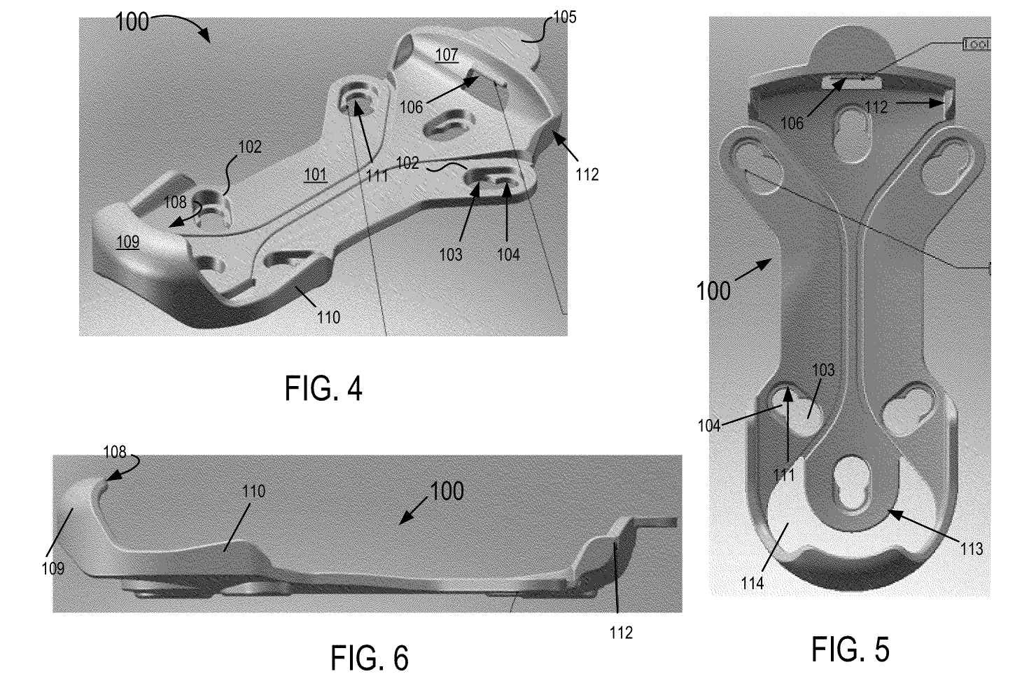

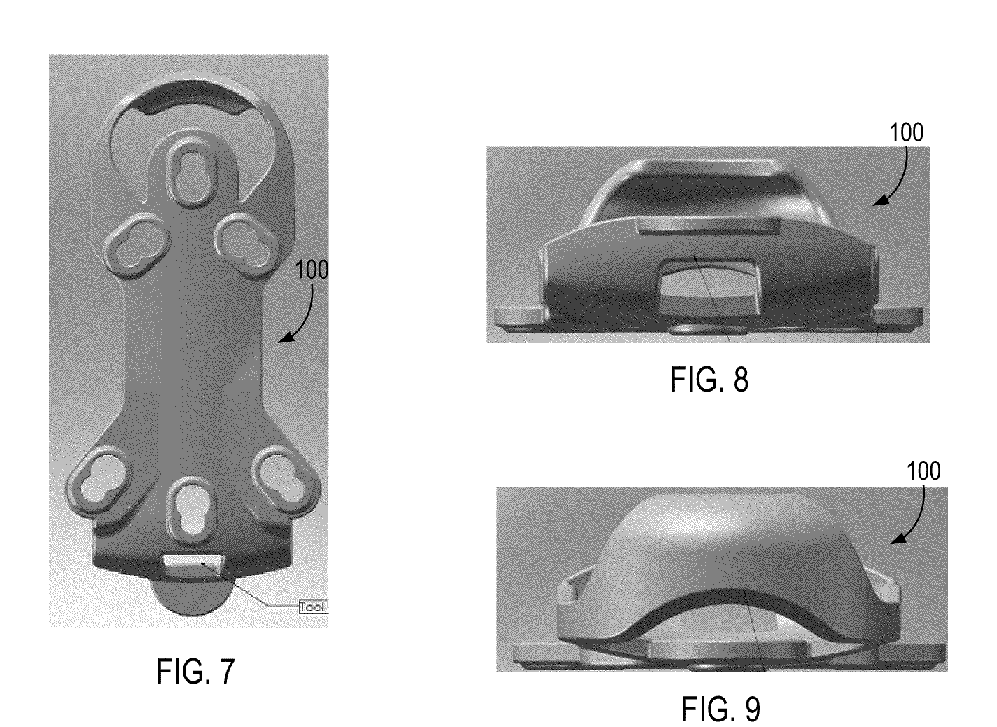

FIG. 4 is a perspective view of the holder of the system in FIG. 1; FIG. 5 a plan view; FIG. 6 a right-side elevational view; FIG. 7 a bottom plan view; FIG. 8 a front plan view; and FIG. 9 is a rear plan view of the holder.

Referring to FIGS. 4-9, holder 100 includes a cavity base 101 that includes two groups of three slots 102. Each slot 102 has a larger aperture 103 and a smaller locking aperture 104, so as to collectively form what is referred to as a keyhole. The smaller aperture 104 includes a shelf feature 111 therein. Each slot 102 is designed to receive a post 133 and flange 132 of a terminal 130 therein, with the post 133 and flange 132 sliding through a neck portion between apertures 103, 104 with resistance and onto the shelf feature 111 to engage the smaller aperture, seating the terminal yet allowing rotation of the terminal 130 within smaller aperture 104.

Accordingly, the plurality of slots 102 can be understood as being further comprised of a first slot pattern of three slots 102 at an upper end of the base cavity 101, and a second slot pattern of at least two slots 102 below a midpoint of the base cavity 101's length. The first slot pattern includes two outer spaced slots and a central slot, the spacing between the two outer slots serving to reduce the pressure of a lanyard 120 connected to the two outer slots on a sensitive frontal side portion of a wearer 300's neck, and to reduce or prevent roll of the holder system as the wearer moves about. A sixth slot 102 is shown centered laterally toward the bottom end of base cavity below the cavity 101's midpoint.

The rounded bottom end of device 200 is intended to engage first upon being inserted into the holder 100. End Lip 109 with edge 108 serves to easily capture and retain the rounded bottom end of device 200. Side edge lips 110 and 112 serve to align and retain device 200 with base cavity 101. Side edge lips 110, being smaller near the bottom and increasing in height, serve to allow a broad range of angles (yaw) as the device 200 initially engages within lips 109 and 108, and to then provide an incremental and automatic correction of yaw as the user continues inserting device 200. Edge lips 112 further ensure final yaw correction and then lateral retention of device 200. End lip 107 with tab 106 bears against the top of device 100 so that device 200 snaps into cavity base 101. Side edge lips 110 are shown integral with bottom end lip 109 (see for example, FIGS. 4-6) and extend partway up the length of holder 100; side edge lips 112 are integral with top end lip 107 and curl slightly around base cavity 101, forming truncated upper sides. A push tab 105 is provided at the top end of holder 100, and is actuated with downward pressure so as to release the device 200 out of the holder 100. Applying downward pressure to push tab 105 unseats tab 106 from device 200.

As best shown in FIG. 5, the base cavity 101 has a protruding plate 113 for central slot 102 (the aforementioned sixth slot) which extends into a semi-circular slot 114. The sixth slot within plate 113 permits a terminal 130 that is attached to an external article such as the retractor 150 or ID holder 175 to be attached to the central lower end of holder 100. The side slots 102 at both top and bottom ends, and on the lower side when the holder 100 is worn non-vertically, also allow a terminal 130 to be attached and an ID holder 175 or other article suspended below the holder 100. These slot 102 configurations serve multiple purposes. For example, they serve to maintain a separation of the external articles and the holder 100, in situations where the user is wearing additional articles like ID badges or keys which, if not positioned and retained properly, may naturally collide with the main device 200 as the wearer 300 moves about, causing problems like noise interference or depression of buttons on the device 200. Also, combining numerous articles and devices into a single holder 100 reduces the number of things a wearer 300 has to don, stabilize, and keep track of.

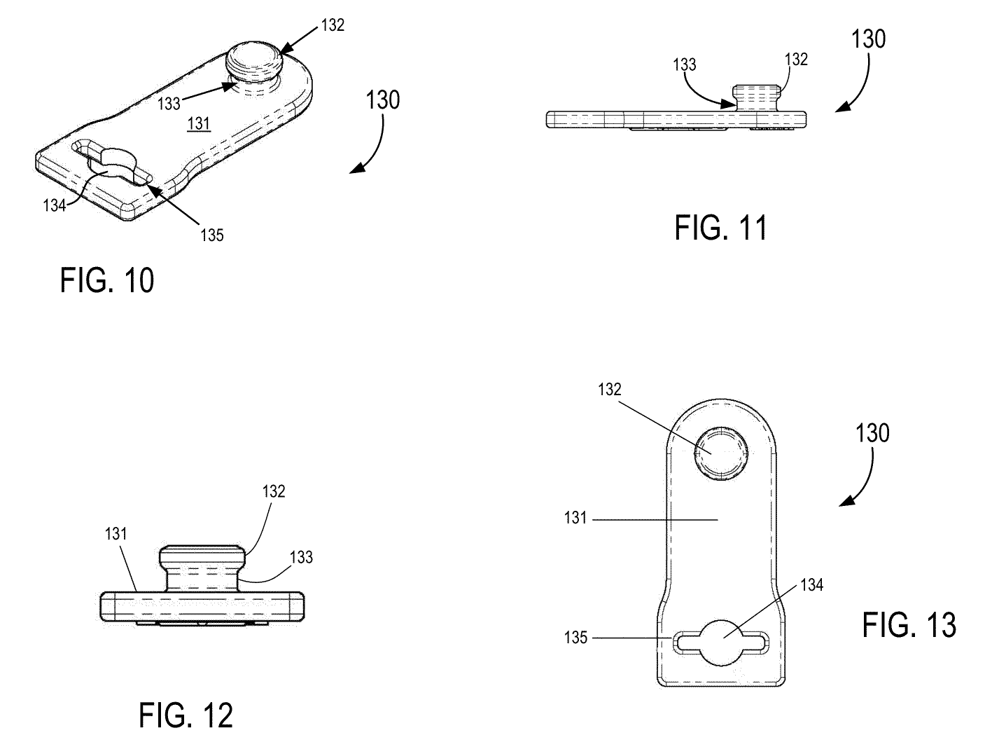

FIG. 10 is a perspective view of the terminal of the system in FIG. 1; FIG. 11 a left-side elevational view; FIG. 12 a front plan view of the terminal; and FIG. 13 is a top plan view of the terminal. Referring to FIGS. 10-13, there is shown the structure of terminal 130, which includes a base 131, and at an upper end thereof a flange 132 which extends from circular post 133, and a longitudinal slot 135 with round 134 at the lower end of the terminal The round 134 may receive a post or rivet and/or may hold a clip 180. The longitudinal slot 135 with round 134 facilitates engagement of an external article thereto, such as the lanyard 120, clip 180, connector 140 for ID holder 175 directly, retractor mechanism 150, or other external article. The connection of any one of these to the terminal 130 at slot 135 serves as a terminal joint.

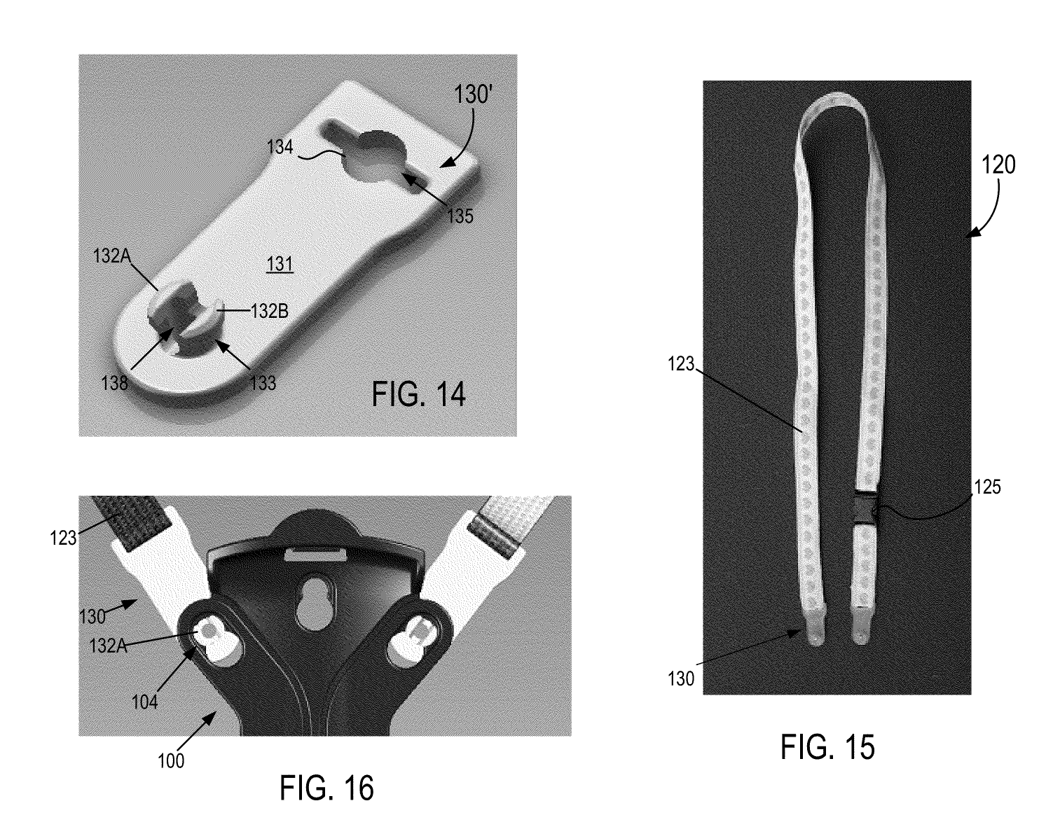

FIG. 14 is a perspective view of a terminal in accordance with another example embodiment. Here, the flange is split into two flange rails 132A and 132B. The split spacing 138 between flange rails 132A, 132B is to allow for terminal 130 to be to torqued out of the keyhole instead of translated without breaking.

FIG. 15 is a top plan view of the lanyard shown in the system of FIG. 1. Lanyard 120 may be made of a web, fabric material 123 and forms a terminal joint with terminal 130 at slot 135. The joint may be formed by the lanyard material 123 looping through slot 135 and sealed or otherwise attached to the underside of lanyard 120. Alternatively, the end of terminal can have a cam structure that pinches or wedges the end of lanyard material 123 therein. Further, the lanyard material 123 could be riveted, adhered or otherwise attached by hook-and-loop structure (Velcro) to terminal 130 to form the terminal joint.

The lanyard 120 may be provided with a safety release 125. In a variant, the safety release 125 may be integral with the terminal 130. In another variant, the lanyard 120 may be provided with no safety release 125 or multiple safety releases 125. The lanyard may also be adjustable through the incorporation of numerous readily available and common means.

FIG. 16 is close-up enlarged top view showing the terminal to holder connections. As can be seen in FIG. 16, the flange engages the keyhole, specifically the smaller locking aperture 104, to secure the holder 100 and lanyard 120 together. In an operation to secure a terminal 130 in a slot 102, and with occasional reference to FIGS. 5 and 10, the post 133 and flange 132 are inserted into the larger diameter aperture 103, then by manual pressure overcome a neck between the connected apertures 103, 104 so as to be inserted into the smaller aperture 104, with flange 132 seating on the shelf feature 111. Since the post 133 is round, the terminal 130 can rotate freely within aperture 104; it is not fixed in orientation. Accordingly, the adjacent first and second apertures 103, 104 intersect or connect such that one or both of the post 133 and flange 132 encounters resistance and requires manual pressure to slide between aperture 103 and aperture 104.

Alternatively, instead of a post 133 and flange 132 configuration for terminal 130, the terminal 130 may be attached to the holder 100 using snaps, buttons, other fastening means, etc. For example, a male snap portion may be affixed to the terminal to replace flange 132/post 133, with the corresponding female snap part affixed to the holder 100 in place of slot 102.

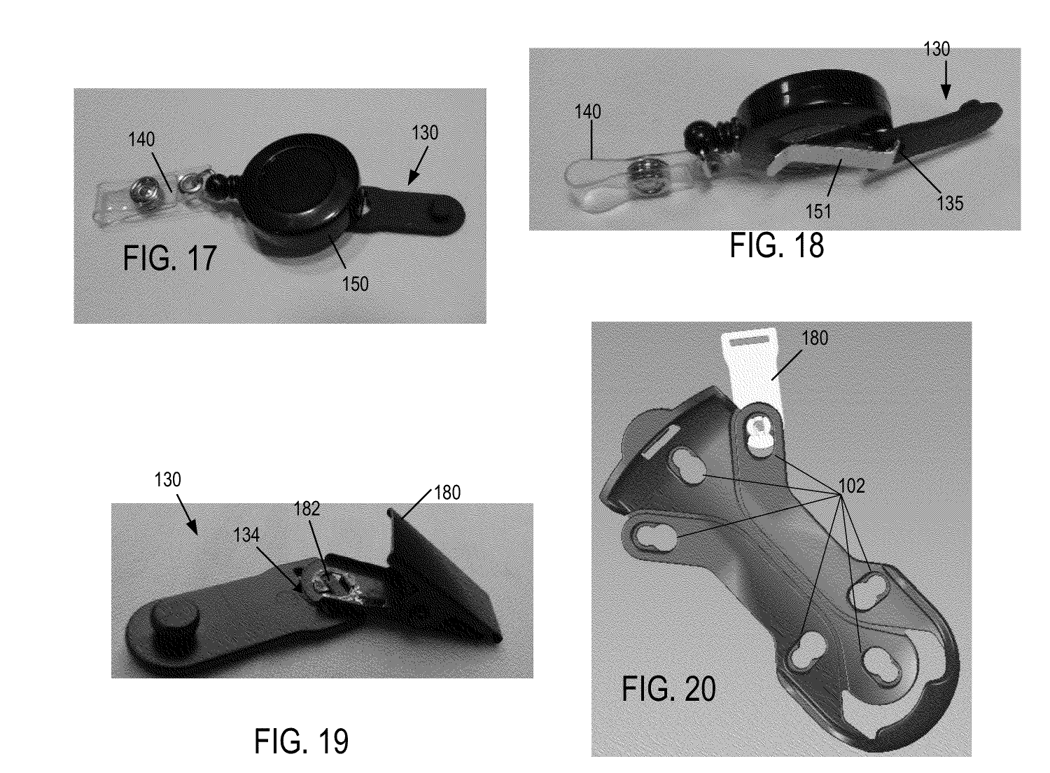

FIG. 17 is a perspective top view of the retractor mechanism shown in the system of FIG. 1 with terminal and ID holder connector attached thereto, with FIG. 18 a perspective side view showing the underside of the retractor mechanism of FIG. 17 to illustrate selected components thereof. Referring to FIGS. 17 and 18, the retractor mechanism 150 includes a terminal 130 connected thereto via its own clip 151 extending through slot 135. The other side shows the connector 140 that may secure an external article such as an ID holder 175 to the retractor mechanism 150.

FIG. 19 is a perspective top view of the clip shown in the system of FIG. 3 with terminal attached thereto. The clip 180 may be affixed to terminal 130 via a locking element 182 or a variety of common means, e.g. rivet, snap, etc. In an example, the clip 180 may have decorative elements thereon, including but not limited to gibbets.

FIG. 20 is a top plan view of the holder showing the terminal to holder connection for the upper breast worn configuration. In FIG. 20, there is shown one location for the clip 180; it being understood that multiple clips 180 and terminals 130 could be used in additional slots 102 to maximize stability and provide near-zero swing of the holder 100 with device 200 therein.

Accordingly, the example embodiments having been described, the aforementioned system 10 provides various configurations using terminal 130 and external articles such as clips or lanyards for wearing holder 100 and for supporting device 200 therein with or without one or more additional external article(s) 175 attached to the holder 100 via a plurality of terminals 130 on the body of the wearer 300. The example configurations substantially reduce the demand on the wearer, e.g., minimize the effort in communicating with others with hands-free use of the device 200. This provides a high degree of automation (i.e., simplicity of securing and stabilizing, and simplicity of usage) that may be desirable to the wearer.

The example embodiments being thus described, it will be obvious that the same may be varied in many ways. For example, system 10 is applicable to myriad combinations of devices, contents and/or uses, including but not limited to: ordering, stock-checking, database-access-entry, bar-code-reading, etc., by the likes of retail sales people (for example, inventory access for retail salespeople, or a food ordering device for a waiter/waitress), delivery people (for example, FedEx, food, precious items), military, and/or factory floor workers.

The example system 10 can be applied to systems for creating recordings for doctors, writers, speakers, scientists, researchers, designers needing to capture thoughts, etc. The system 10 described herein is equally applicable to one or more of instruments, detectors, collectors, weapons, information, tools, equipment, etc. that might be used or desired by the likes of electricians, inspectors, stationary or mobile workers, scuba divers, lab technicians, medical personnel, military, security personnel (police, coast-guard, FBI, etc.), musicians, etc. (for example: for use by a person who roams and tracks energy usage, water levels, pollution, etc.; or for a factory floor worker to track WIP as they move around a factory floor).

The example holder 100 of system 10 with terminals 130 and clips 180 may be further applicable to the carrying of signage or other types of mobile devices; providing protection for the device or contents (from breaking or damage, from being dropped, from theft, etc.); holding it while in use; visibility by user (while in use and/or otherwise); notification to, and/or visibility by, others (e.g., a safety patrol may want to wear a walkie-talkie on the chest so others will know emergency communication is possible, or a sales person at a trade show may want others to see an eye-catching video on an electronic display that he/she is wearing); and for some it may also include elements of fashion, style, or prestige.

Therefore, the example system 10 described above addresses issues and/or creates opportunities or benefits for various different natures including ease of use and/or access, immediacy of access and/or visibility of a device for the user/wearer and/or other(s); protection of the device 200 from breakage, theft, weather, etc; stability; orientation; etc. Such variations are not to be regarded as departure from the example embodiments, and all such modifications as would be obvious to one skilled in the art are intended to be included in the following claims.

I claim:

1. A holder system for supporting a mobile device therein, comprising:
a base cavity adapted to hold the mobile device, which is removable therefrom, the base cavity having a plurality of slots adapted to receive terminals therein,
wherein the plurality of slots is further comprised of a first slot pattern of three slots at an upper end of the base cavity, and a second slot pattern of at least two slots below a midpoint of the base cavity's length, and
at least one external article adapted to be coupled to the base cavity via one of the terminals engaged in one of the slots.

2. The system of claim 1, wherein each terminal further includes:
a base,
a post on the base,
a flange which extends from the post, the flange adapted to engage one of the slots in the base cavity.

3. The system of claim 2, wherein each slot includes:
a first aperture having a first diameter,
a second aperture adjacent the first aperture and having a second diameter smaller than the first, the second aperture including a shelf feature therein, the adjacent first and second apertures connected such that one or both of the post and flange encounters resistance upon sliding from the first aperture into the second aperture, and
wherein the flange of a terminal is adapted to seat along the shelf feature in the second aperture in engagement thereto, the terminal connected to at least one external article.

4. The system of claim 3, wherein the terminal is rotatable in the second aperture while being retained therein.

5. The system of claim 1, wherein the external article is one or more of an ID holder, a lanyard, a clip, and a retractor mechanism.

6. The system of claim 1, wherein the cavity base is an elongate member having a top end lip, a bottom end lip, and side edge lips which extend only partly along upper and lower sides of the elongate member so as to be truncated, the side edge lips configured to assist in holding and aligning the mobile device on the base cavity.

7. The system of claim 6, wherein the top end lip includes a locking tab to secure the mobile device in the base cavity, and includes a push tab to release the locking tab from the mobile device to allow the mobile device to be removed from the base cavity.

8. The system of claim 1, wherein the base cavity includes, at a lower end thereof, a sixth slot therein, positioned at a center of the base cavity.

9. The system of claim 1, wherein the mobile device has at least one microphone or microphone system, and a lanyard supports the system on a wearer's chest so that the at least one microphone or microphone system is oriented toward the mouth of the wearer.

10. The system of claim 1, wherein the mobile device has at least one microphone, and at least one clip supports the system on a wearer's chest so that the microphone is positioned toward the mouth of the wearer.

11. The system of claim 1, wherein the first slot pattern includes two outer spaced slots with a central slot therebetween, the spacing between the two outer slots serving to reduce the pressure of a lanyard connected to the two outer slots on a frontal side portion of a wearer's neck.

12. A holder for supporting a mobile device therein, comprising.
a base cavity adapted to hold the mobile device, the base cavity having a plurality of slots adapted to receive corresponding terminals therein, one or more of the terminals connected to external article,
a top end lip extending from the base cavity for bounding an upper end of the device,
a bottom end lip extending from the base cavity for bounding a lower end of the device, and
a plurality of side edge lips for partially bounding respective upper sides and lower sides of the device, the side edge lips configured to assist in holding and aligning the mobile device on the base cavity.

13. The holder of claim 12, wherein the top end lip includes a locking tab to secure the mobile device in the base cavity, and includes a push tab to release the locking tab from the mobile device to allow the mobile device to be removed from the base cavity.

14. The holder of claim 12, wherein each terminal further includes a flange adapted to engage a corresponding slot in the base cavity.

15. The holder of claim 14, wherein each slot includes:
a first aperture having a first diameter,
a second aperture adjacent the first aperture and having a second diameter smaller than the first, the second aperture including a shelf feature therein, the adjacent first and second apertures connected such that one or both of the post and flange encounters resistance upon sliding from the first aperture into the second aperture, and
wherein the flange of a terminal is adapted to seat along the shelf feature in the second aperture in engagement thereto, the terminal connected to at least one external article.

16. The holder of claim 15, wherein the terminal is rotatable in the second aperture while being retained therein.

17. A terminal structure usable with a holder for a mobile device, the holder having a plurality of slots for receiving the terminal structure, comprising.
a base,
a post attached to the base at one end of the base,
a flange provided on the post, the flange adapted for engagement with a slot on the holder to secure the terminal structure to the holder, and
a slot at the other end of the base for receiving an article external to the holder and mobile device.
